(19) United States
(12) Patent Application Publication
(10) Pub. No.: US 2024/0075922 A1
(43) Pub. Date: Mar. 7, 2024

(54) METHOD AND SYSTEM FOR SENSOR FUSION FOR VEHICLE

(71) Applicants: HYUNDAI MOTOR COMPANY, Seoul (KR); KIA CORPORATION, Seoul (KR)

(72) Inventors: Nam Hyung Lee, Seoul (KR); Bo Young Yun, Hwaseong-si (KR)

(73) Assignees: HYUNDAI MOTOR COMPANY, Seoul (KR); KIA CORPORATION, Seoul (KR)

(21) Appl. No.: 18/224,807

(22) Filed: Jul. 21, 2023

(30) Foreign Application Priority Data
Sep. 5, 2022 (KR) 10-2022-0112154

(51) Int. Cl. B60W 30/095

(52) U.S. Cl. CPC B60W 30/095; B60W 2420/52; B60W 2554/4049

(57) ABSTRACT

A method for sensor fusion for a vehicle, includes determining a first point corresponding to a closest point of a target object from the vehicle with respect to a potential collision based on a LiDAR track thereof and a heading of the vehicle, determining a second point corresponding to a closest point of the target object from the vehicle with respect to a potential collision based on a sensor fusion track, and updating the sensor fusion track based on the first point and the second point.

### CROSS-REFERENCE TO RELATED APPLICATION

The present application claims priority to Korean Patent Application No. 10-2022-0112154, filed on Sep. 5, 2022, the entire contents of which is incorporated herein for all purposes by this reference.

### BACKGROUND OF THE PRESENT DISCLOSURE

### Field of the Present Disclosure

The present disclosure relates to a method and a system for a sensor for a vehicle

### Description of Related art

The autonomous driving system of the vehicle includes a sensor fusion system capable of generating and outputting a sensor fusion track for a target object (i.e., a target vehicle) based on data obtained by a plurality of sensing devices, for example, a Light Detection and Ranging (LiDAR), a radar, and/or a camera.

For example, the sensor fusion track output through the sensor fusion system may be generated by selecting and processing data obtained by the sensing device, for example, values required for a longitudinal position, a lateral position, a heading, a width, and/or a length of the target vehicle.

To avoid a collision between the vehicle and the target vehicle, a closest point (CP) (also referred to as a point of potential collision or a closest point of potential collision closest point) where a collision with the vehicle is most imminent on the sensor fusion track needs to be reflected as close as possible to a current state.

However, in the sensor fusion system according to the related art, although the track fusion is performed according to the detailed strategy, the position of the closest point of potential collision of the actual target vehicle on the output sensor fusion track is different from the position of the closest point of potential collision of an actual target vehicle according to the arrangement situation between the vehicle and the target vehicle and the driving situation of the vehicle and the target vehicle.

The information disclosed in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and system for detecting a vehicle sensor, which improves the position accuracy of the closest point of potential collision against a self-driving vehicle on the sensor fusion track with respect to the target vehicle, as compared to the related art.

A method for sensor fusion for a vehicle, according to an exemplary embodiment of the present disclosure, includes determining a first point corresponding to a closest point of a target object from the vehicle with respect to a potential collision based on a Light Detection and Ranging (LiDAR) track thereof and a heading of the vehicle, determining a second point corresponding to a closest point of the target object from the vehicle with respect to a potential collision based on a sensor fusion track, and updating the sensor fusion track based on the first point and the second point.

In at least an exemplary embodiment of the present disclosure, the determining of the first point includes determining a first heading of the LiDAR track based on the heading of the vehicle, determining a first midpoint of a first track side corresponding to an opposite side of the first heading in the LiDAR track, and determining, in the LiDAR track, whether the first point is located at a left corner or a right corner of the first track side based on the first midpoint.

In at least an exemplary embodiment of the present disclosure, the determining of the first heading includes determining four potential headings of the LiDAR track based on a shape of the LiDAR track, and determining, as the first heading, a potential heading including a heading angle with a smallest difference from the heading angle of the vehicle among the four potential headings.

In at least an exemplary embodiment of the present disclosure, the determining of the first point includes determining a position of a left corner of the first track side and a position of a right corner of the first track side based on a center coordinate value of the LiDAR track, a length of the LiDAR track, a width of the LiDAR track, and an angle of the first heading.

In at least an exemplary embodiment of the present disclosure, the determining of whether the first point is located at the left corner or the right corner is based on an equation of a straight line connecting a midpoint of the LiDAR track and the first midpoint and a coordinate value of the first point.

In at least an exemplary embodiment of the present disclosure, the equation is Ax+By+C=0, A, B, and C being real numbers, and wherein when a sum of a value obtained by multiplying A by a longitudinal coordinate value of the first point, a value obtained by multiplying B by a lateral coordinate value of the first point, and a value of C is less than 0, the first point is determined to be located at the left corner, and when the sum is greater than 0, the first point is determined to be located at the right corner.

In at least an exemplary embodiment of the present disclosure, the determining of the first point is based on a linear distance of the LiDAR track from an origin of a vehicle coordinate system, a lateral distance of the LiDAR track from the origin, or a longitudinal distance of the LiDAR track from the origin.

In at least an exemplary embodiment of the present disclosure, when the LiDAR track is located in a right lane of the vehicle, the determining of the first point includes determining the first point based on the lateral distance when a difference value between an angle of the first midpoint and an angle of the first heading is a positive value based on the origin of the vehicle coordinate system, and determining the first point based on the linear distance when the difference value is a negative value.

In at least an exemplary embodiment of the present disclosure, when the LiDAR track is located in a left lane of the vehicle, the determining of the first point includes determining the first point based on the linear distance when a difference value between the angle of the first midpoint and the angle of the first heading is a positive value based on the origin of the vehicle coordinate system, and determining the first point based on the lateral distance when the difference value is the negative value.

In at least an exemplary embodiment of the present disclosure, the determining of the second point includes determining a second heading of the sensor fusion track based on the first heading, determining that the second point is located at a left corner of a second track side corresponding to an opposite side of the second heading when the first point in the LiDAR track is located at the left corner of the first track side, and determining that the second point is located at a right corner of the second track side when the first point in the LiDAR track is located at the right corner of the first track side.

In at least an exemplary embodiment of the present disclosure, the determining a position of the left corner of the second track side and a position of the right corner of the second track side based on a center coordinate value of the sensor fusion track, a length of the sensor fusion track, a width of the sensor fusion track, and an angle of the second heading.

In at least an exemplary embodiment of the present disclosure, the updating of the sensor fusion track includes adjusting a longitudinal coordinate value of a midpoint of the second track side based on a difference value between a longitudinal coordinate value of the first point and a longitudinal coordinate value of the second point, and adjusting a lateral coordinate value of the midpoint of the second track side based on a difference value between a lateral coordinate value of the first point and a lateral coordinate value of the second point.

A system for sensor fusion for a vehicle, according to an exemplary embodiment of the present disclosure, includes a memory configured to store a sensor fusion track generated with respect to a target object, and a processor electrically or communicatively connected to the memory, wherein the memory stores instructions which are executable by the processor and the processor is configured, by executing the instructions, to determine a first point corresponding to a closest point of a target object from the vehicle with respect to a potential collision based on a Light Detection and Ranging (LiDAR) track thereof and a heading of the vehicle, determine a second point corresponding to a closest point of the target object from the vehicle with respect to a potential collision based on a sensor fusion track, and update the sensor fusion track based on the first point and the second point.

In at least an exemplary embodiment of the system, the processor, to determine the first point, is further configured to determines a first heading of the LiDAR track based on the heading of the vehicle, determines a first midpoint of a first track side corresponding to an opposite side of the first heading in the LiDAR track, and determines, in the LiDAR track, whether the first point is located at a left corner or a right corner of the first track side based on the first midpoint.

In at least an exemplary embodiment of the system, the processor, to determine the first point, is further configured to determine a position of a left corner of the first track side and a position of a right corner of the first track side based on a center coordinate value of the LiDAR track, a length of the LiDAR track, a width of the LiDAR track, and an angle of the first heading.

In at least an exemplary embodiment of the system, the processor is further configured to determine whether the first point is located at the left corner or the right corner based on an equation of a straight line connecting a midpoint of the LiDAR track and the first midpoint and a coordinate value of the first point.

In at least an exemplary embodiment of the system, the processor is further configured to determine the first point based on a linear distance of the LiDAR track from an origin of a vehicle coordinate system, a lateral distance of the LiDAR track from the origin, or a longitudinal distance of the LiDAR track from the origin.

In at least an exemplary embodiment of the system, the processor, to determine the second point, is further configured to determines a second heading of the sensor fusion track based on the first heading, determines that the second point is located at a left corner of a second track side corresponding to an opposite side of the second heading when the first point in the LiDAR track is located at the left corner of the first track side, and determines that the second point is located at a right corner of the second track side when the first point in the LiDAR track is located at the right corner of the first track side.

In at least an exemplary embodiment of the system, the processor is further configured to determine a position of the left corner of the second track side and a position of the right corner of the second track side based on a center coordinate value of the sensor fusion track, a length of the sensor fusion track, a width of the sensor fusion track, and an angle of the second heading.

In at least an exemplary embodiment of the system, the processor is further configured to adjust a longitudinal coordinate value of the midpoint of the second track side based on a difference value between a longitudinal coordinate value of the first point and a longitudinal coordinate value of the second point, and adjust a lateral coordinate value of the midpoint of the second track side based on a difference value between a lateral coordinate value of the first point and a lateral coordinate value of the second point.

For example, the sensor fusion method and system of embodiments of the present disclosure can improve position accuracy of the sensor fusion track by matching the closest point of potential collision against the self-driving vehicle in the sensor fusion track with the closest point of collision with the self-driving vehicle in the track generated by the data of a front corner LiDAR (FCL), before the sensor fusion system ultimately outputs the sensor fusion track generated with the conventional technology.

The method and system for a sensor for a vehicle according to the exemplary embodiment of the present disclosure may increase the position accuracy of the closest point of potential collision with the self-driving vehicle in the sensor fusion track for the target vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1A and FIG. 1B are diagrams illustrating a sensor fusion track and a LiDAR track according to the related art and a sensor fusion track and a LiDAR track according to an exemplary embodiment of the present disclosure.

FIG. 2 is a block diagram of a vehicle according to an exemplary embodiment of the present disclosure.

FIG. 3 is a flowchart of an operation of a sensor fusion system of a vehicle according to an exemplary embodiment of the present disclosure.

FIG. 4 is a flowchart of an operation of a sensor fusion system of a vehicle according to an exemplary embodiment of the present disclosure.

FIG. 5, FIG. 6, FIG. 7A and FIG. 7B, FIG. 8, and FIG. 9 are diagrams for describing an operation of a sensor fusion system of a vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In case where identical elements are included in various exemplary embodiments of the present disclosure, they will be provided the same reference numerals, and redundant description thereof will be omitted. In the following description, the terms “module” and “unit” for referring to elements are assigned and used interchangeably in consideration of convenience of explanation, and thus, the terms per se do not necessarily have different meanings or functions.

Furthermore, in describing the exemplary embodiments of the present disclosure, when it is determined that a detailed description of related publicly known technology may obscure the gist of the exemplary embodiments of the present disclosure, the detailed description thereof will be omitted. The accompanying drawings are used to help easily explain various technical features and it should be understood that the exemplary embodiments presented herein are not limited by the accompanying drawings. Accordingly, the present disclosure should be construed to extend to any alterations, equivalents and substitutes in addition to those which are particularly set out in the accompanying drawings.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Unless otherwise defined, all terms including technical and scientific ones used herein include the same meanings as those commonly understood by one of ordinary skill in the art to which this invention belongs. It will be further understood that terms, such as those defined in commonly used dictionaries, should be interpreted as having meanings consistent with their meanings in the context of the relevant art and the present disclosure, and are not to be interpreted in an idealized or overly formal sense unless so defined herein.

Furthermore, the term “unit” or “control unit” included in the names of a hybrid control unit (HCU), a motor control unit (MCU), etc. is merely a widely used term for naming a controller configured for controlling a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform calculation, determination, decision, etc. necessary for controlling a function assigned thereto.

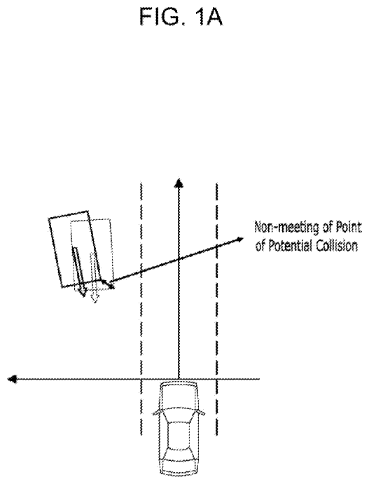

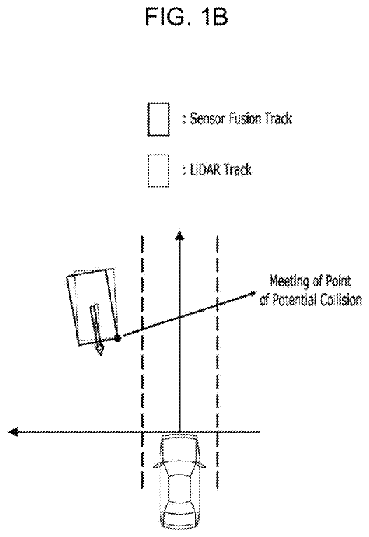

FIG. 1A and FIG. 1B are diagrams illustrating a sensor fusion track and a LiDAR track according to the related art and a sensor fusion track and a LiDAR track according to an exemplary embodiment of the present disclosure.

Referring to FIGS. 1A and 1B, in a case where a target vehicle travels toward a self-driving vehicle (hereinafter, referred to as simply ‘the vehicle’) at a high speed (i.e., a speed higher than a predetermined speed), as illustrated in FIG. 1A, the potential collision point between a sensor fusion track output from a system in a conventional sensor fusion process and a LiDAR track generated based on LiDAR data obtained through a LiDAR sensor provided in the vehicle may not coincide with each other. In the present situation, when the vehicle is performing autonomous driving control, fast longitudinal control of the vehicle is required, but longitudinal control of the vehicle is delayed due to a mismatch between collision prediction points of the sensor fusion track and the LiDAR track, and thus a collision accident may occur.

On the other hand, in a track (hereinafter, also referred to as a LiDAR track) of the target object generated based on the LiDAR data, a position of a collision prediction point of the target object closest to the vehicle may be more accurate than a position of a collision prediction point on the track generated based on data of other sensing devices of the vehicle.

According to the point described above, according to the exemplary embodiment of the present disclosure, the position accuracy of the sensor fusion track may be improved by matching the position of the predicted collision closest point on the sensor fusion track with the predicted collision closest point (hereinafter, also referred to as the predicted collision closest point) on the LiDAR track as illustrated in FIG. 1B, before finally outputting the sensor fusion track for the object.

Hereinafter, operation principles and embodiments of the present disclosure will be described with reference to the accompanying drawings.

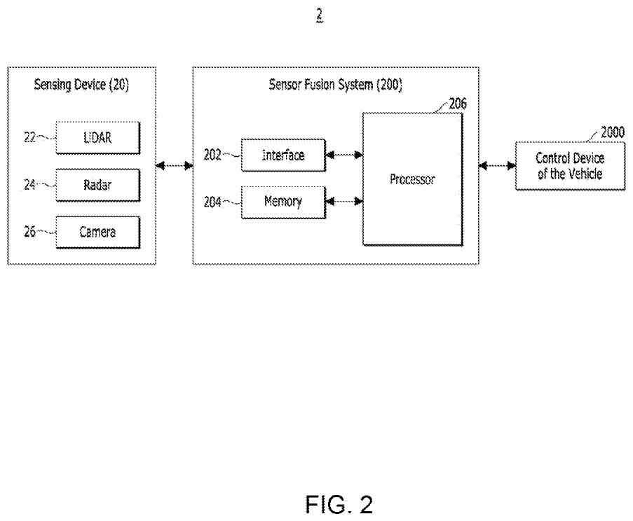

FIG. 2 is a block diagram of a vehicle according to an exemplary embodiment of the present disclosure.

Referring to FIG. 2, the vehicle 2 may include a sensing device 20, a sensor fusion system 200, and a vehicle control device 2000.

The sensing device 20 may include one or more devices configured for obtaining information on objects located around the vehicle 2, for example, information on a target vehicle.

The sensing device 20 may include a LiDAR (sensor) 22, a radar 24, and/or a camera 26.

The LiDAR 22 may detect an object by scanning the surroundings of the vehicle 2.

For example, the LiDAR 22 may include a front-side LiDAR to scan the front side region of the vehicle 2 and detect objects.

The radar 24 may detect objects around the vehicle 2.

For example, the radar 24 may include a front radar provided in the front side of the vehicle 2, a first corner radar provided in the front right side of the vehicle 2, a second corner radar provided in the front left side, a third corner radar provided in the rear right side, and/or a fourth corner radar provided in the rear left side to have detection fields of view toward the front, front right, front left, rear right, and/or right left side regions of the vehicle 2.

The camera 26 may obtain image data of the surroundings of the vehicle 2 and monitor the surroundings of the vehicle 2.

For example, the camera 26 may include a wide-angle camera, a front camera, a right camera, a left camera, and/or a rear-side view camera.

The sensor fusion system 200 may initially generate a sensor fusion track for each of one or more objects, for example, one or more target vehicles, based on the data received from the sensing device 20, and update the generated sensor fusion track.

The sensor fusion system 200 may include an interface 202, a memory 204, and a processor 206 (e.g., computer, microprocessor, CPU, ASIC, circuitry, logic circuits, etc.).

The interface 202 may be configured to transfer instructions or data input from another device of the vehicle 2 or a user to another component of the sensor fusion system 200, or output instructions or data received from another component of the sensor fusion system 200 to another device of the vehicle 2.

The interface 202 may include a communication module to communicate with the sensing device 20 and/or the vehicle control device 2000.

For example, the communication module may include a communication module configured for performing communication between devices of the vehicle 2, for example, Controller Area Network (CAN) communication and/or Local Interconnect Network (LIN) communication, through a vehicle communication network. Furthermore, the communication module may include a wired communication module (i.e., a power line communication module) and/or a wireless communication module (i.e., a cellular communication module, a Wi-Fi communication module, a short-range wireless communication module, and/or a global navigation satellite system (GNSS) communication module).

The memory 204 connected to the sensing device 20 may store various data used by at least one component of the sensor fusion system 200, e.g., input data and/or output data for a software program and instructions related thereto.

The memory 204 connected to the processor 206 may store sensing data received from the sensing device 20, data obtained by the processor 206, data output by the processor 206 (e.g., sensor fusion track data), etc. For example, the memory 204 may store a sensor fusion track generated with respect to the target object through sensing data received from the sensing device 20. Also, the memory 204 may store an algorithm or instructions for executing sensor fusion and the like.

For example, the memory 204 may include a non-volatile memory such as cache, Read Only Memory (ROM), Programmable ROM (PROM), Erasable Programmable ROM (EPROM), Electrically Erasable Programmable ROM (EEPROM), and/or Flash memory, and/or volatile memory such as Random Access Memory (RAM).

The processor 206 may perform sensor fusion based on the sensing data received from the sensing device 20 through the interface 202. The processor 206 may provide result data according to the performance of the sensor fusion to the vehicle control device 2000 through the interface 202 so that the vehicle control device 2000 controls the driving of the vehicle 2.

For example, the processor 206 may be configured to generate a sensor fusion track for the target vehicle based on sensing data of the sensing device 20 received through the interface 202 through a related art of configured for generating a sensor fusion track, and may store the generated sensor fusion track in the memory 204.

Furthermore, the processor 206 may perform an additional operation to update the generated sensor fusion track for improving accuracy of the sensor fusion track for the target vehicle.

For example, the processor 206 may be configured to determine a first point corresponding to a potential collision closest point between the vehicle 2 and the target object based on the LiDAR track generated for the target object by use of the LiDAR data obtained from the LiDAR 22. Furthermore, the processor 206 may be configured to determine a second point corresponding to the closest point of potential collision between the vehicle 2 and the target object based on the sensor fusion track generated for the target object. Also, the processor 206 may update the sensor fusion track based on the first point and the second point.

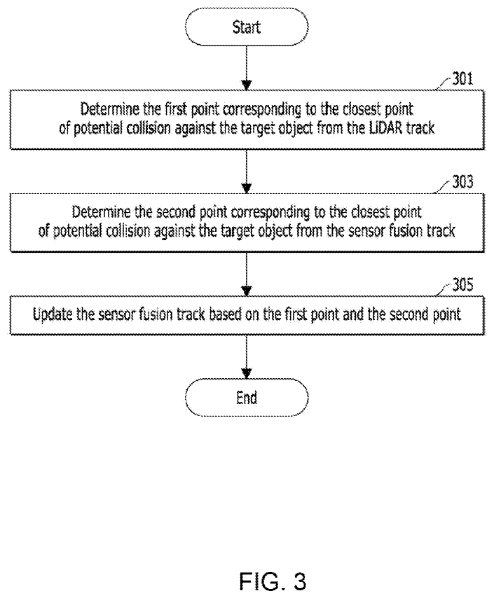

FIG. 3 is a flowchart of an operation of the sensor fusion system 200 (and/or the processor 206) of the vehicle 2 according to an exemplary embodiment of the present disclosure.

Referring to FIG. 3, the sensor fusion system 200 may be configured to determine the first point corresponding to a potential closest point to collide between the vehicle 2 and the target object based on a LiDAR track generated for the target object through the LiDAR data of the LiDAR 22 (301).

For example, the sensor fusion system 200 may be configured to determine the heading of the LiDAR track (hereinafter referred to as a first heading) based on the heading of the vehicle 2 in the vehicle coordinate system.

The sensor fusion system 200 may be configured to determine a midpoint (also referred to as a first midpoint) of a track side (also referred to as a first track side) corresponding to an opposite side of the first heading in the LiDAR track based on the first heading. The sensor fusion system 200 may be configured to determine a position of a left corner (also referred to as a lower left corner of the LiDAR track) connected to the LiDAR track and a position of a right corner (also referred to as a lower right corner of the LiDAR track) connected to the first track side.

The sensor fusion system 200 may be configured to determine the first point by applying one of the conditions of a straight-line distance of the LiDAR track from the origin of the vehicle coordinate system, a transverse distance of the LiDAR track from the origin of the vehicle coordinate system, and the longitudinal distance of the LiDAR track from the origin of the vehicle coordinate system. One condition for determining the first point may be determined based on whether the LiDAR track is located in the right lane, the left lane, or the same lane of the vehicle 2, and whether the difference value between the angle of the first midpoint and the angle of the first heading based on the origin of the vehicle coordinate system is negative or positive.

The sensor fusion system 200 may be configured to determine based on the LiDAR track whether the first point is located at the left corner or the right corner connected to the first track side.

The sensor fusion system 200 may be configured to determine a second point corresponding to the closest point of potential collision between the vehicle 2 and the target object based on the sensor fusion track generated for the target object (303).

For example, the sensor fusion system 200 may initially determine the first heading of the LiDAR track and the heading of the sensor fusion track (also referred to as a second heading).

The sensor fusion system 200 may be configured to determine a midpoint (also referred to as a second midpoint) of a track side (also referred to as a second track side) corresponding to the opposite side of the second heading in the sensor fusion track based on the second heading. The sensor fusion system 200 may be configured to determine a position of the left corner (also referred to as a lower left corner of the sensor fusion track) connected to the second track side in the sensor fusion track and the position of a right corner (also referred to as a lower right corner of the sensor fusion track) connected to the second track side.

The sensor fusion system 200 may be configured to conclude that the second point is located at the left corner connected to the second track side when the first point on the LiDAR track is located at the left corner connected to the first track side. The sensor fusion system 200 may be configured to conclude that the second point is located at the right corner connected to the second track side when the first point on the LiDAR track is located at the right corner connected to the first track side.

The sensor fusion system 200 may update the sensor fusion track based on the first point and the second point (305).

For example, the sensor fusion system 200 may adjust the longitudinal coordinate value of the midpoint of the second track side of the sensor fusion track based on the difference value between the longitudinal coordinate value of the first point and the longitudinal coordinate value of the second point. Furthermore, the sensor fusion system 200 may adjust the lateral coordinate value of the midpoint of the second track side of the sensor fusion track based on the difference value between the lateral coordinate value of the first point and the lateral coordinate value of the second point.

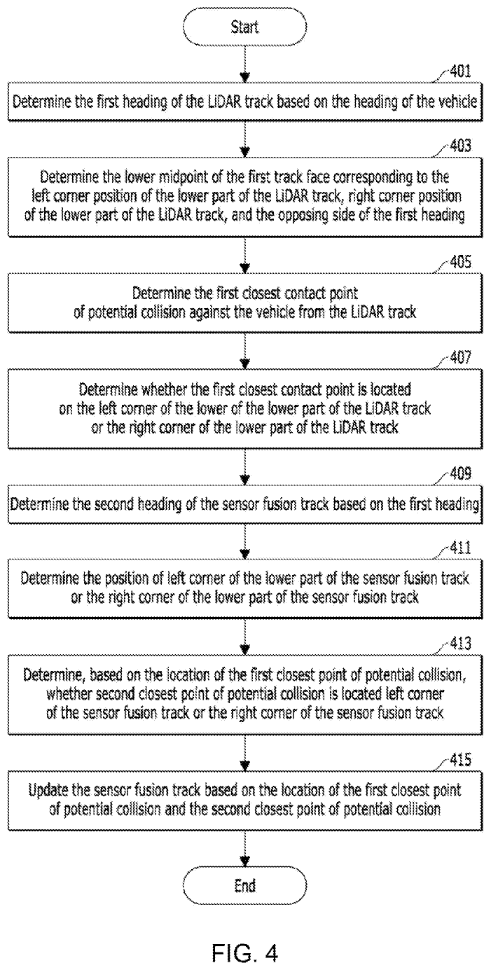

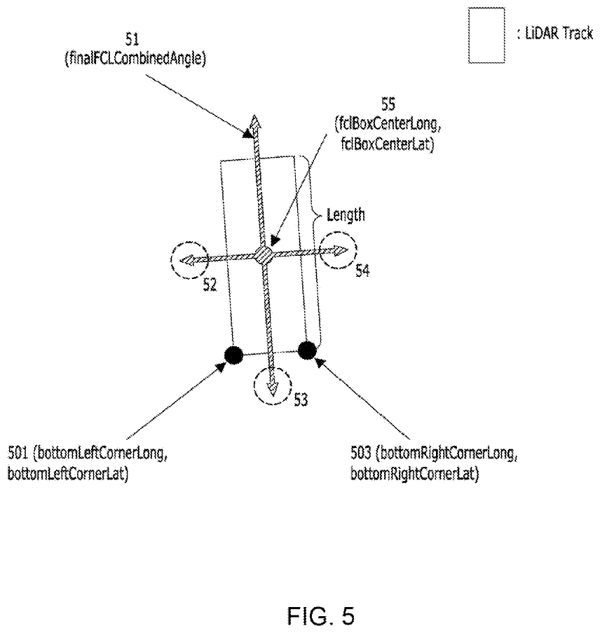

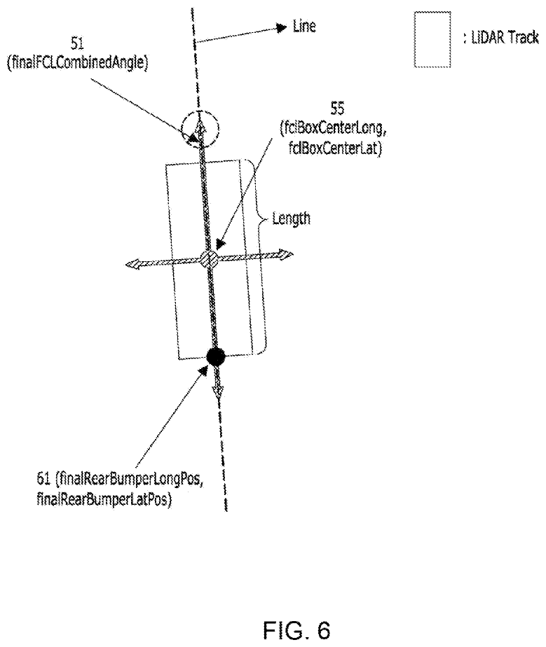

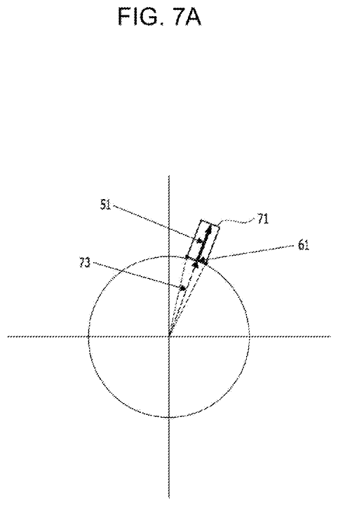

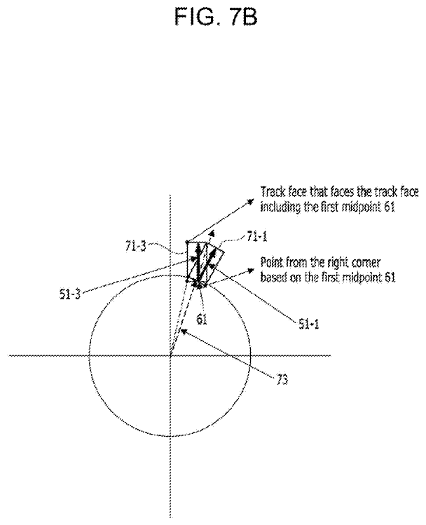

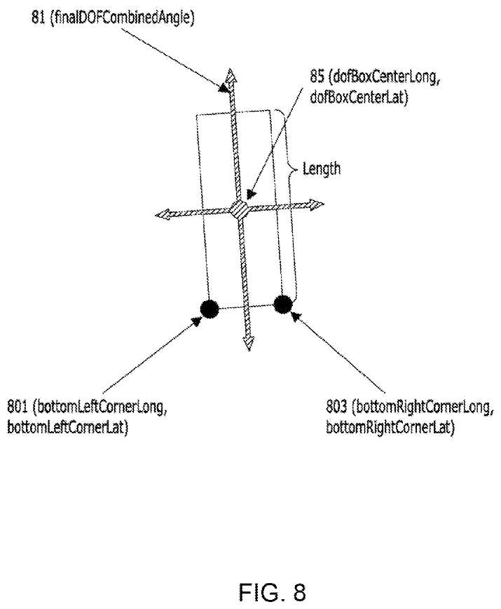

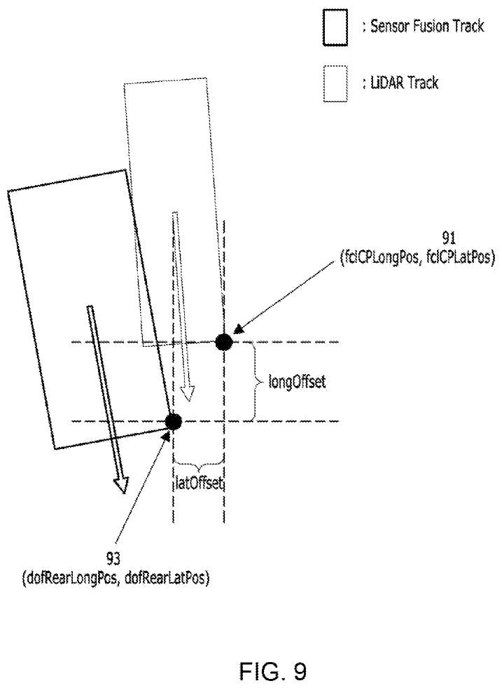

A detailed embodiment of updating the sensor fusion track will be described later with reference to FIG. 4, FIG. 5, FIG. 6, FIG. 7A AND FIG. 7B, FIG. 8, and FIG. 9.

Hereinafter, a left corner of the LiDAR track connected to the first track side may be referred to as a left corner of a lower portion of the LiDAR track, and the right corner of the LiDAR track connected to the first track side may be referred to as a right corner of a lower portion of the LiDAR track.

Also, hereinafter, a left corner of the sensor fusion track connected to the second track side may be referred to as the left corner of the lower portion of the sensor fusion track, and a right corner of the sensor fusion track connected to the second track side may be referred to as a right corner of the lower portion of the sensor fusion track.

FIG. 4 is a flowchart of an operation of the sensor fusion system 200 (and/or the processor 206) of the vehicle 2 according to an exemplary embodiment of the present disclosure.

FIG. 5, FIG. 6, FIG. 7A and FIG. 7B, FIG. 8, and FIG. 9 are diagrams for describing an operation of the sensor fusion system 200 (and/or the processor 206) of the vehicle 2 according to the embodiment.

Referring to FIG. 4, the sensor fusion system 200 may be configured to determine a first heading of the LiDAR track based on the heading of the vehicle 2 (401).

For example, the sensor fusion system 200 may be configured to determine four potential headings of the LiDAR track based on a shape of the LiDAR track. The sensor fusion system 200 may determine, as the first heading, a potential heading including a heading angle including the smallest difference from the heading angle of the vehicle 2 among the four potential headings.

Referring to FIG. 5, the LiDAR track may include a rectangular box shape.

In the sensor fusion system 200, a direction toward the outside of a box shape may be determined as a potential heading from a midpoint 55 (also referred to as a midpoint of the LiDAR track) of the box shape to four sides (also referred to as track sides) forming the box shape, and the potential headings may be four headings 51, 52, 53, and 54 as illustrated in FIG. 5.

The sensor fusion system 200 may be configured to determine one potential heading corresponding to the heading of the vehicle 2, that is, corresponding to the heading direction and heading angle of the vehicle 2, among the four potential headings 51, 52, 53, and 54 as the first heading.

For example, the sensor fusion system 200 may be configured to determine one potential heading including a heading angle closest to the heading angle (0°) of the vehicle coordinate system of the vehicle 2 among the four optional headings 51, 52, 53, and 54 as the first heading. For example, in FIG. 5, the heading 51 may be determined as the first heading.

Based on the first heading, the sensor fusion system 200 may be configured to determine a midpoint (also referred to as a first midpoint) of a lower portion of the first track side corresponding to the left corner of a lower portion of the LiDAR track, the right corner of the lower portion of the LiDAR track, and the opposite side of the first heading on the vehicle coordinate system (403).

The sensor fusion system 200 may be configured to determine a left corner position of a lower portion of the LiDAR track and the right corner of the lower portion of the LiDAR track based on a central coordinate value (a longitudinal coordinate value (fclBoxCenterLong) and the lateral coordinate value (fclBoxCenterLat) of the LiDAR track, a length of the LiDAR track, the width of the LiDAR track, and the first heading angle (finalFCLCombinedAngle).

The sensor fusion system 200 may be configured to determine the left corner of the lower portion of the LiDAR track and the right corner of the lower portion of the LiDAR track based on Equation 1 below.

bottomLeftCornerLong=fclBoxCenterLong−0.5*Length*cos(finalFCLCombinedAngle)−0.5*Width*sin(finalFCLCombinedAngle)

bottomLeftCornerLat=fclBoxCenterLat−0.5*Length*sin(finalFCLCombinedAngle)+0.5*Width*cos(finalFCLCombinedAngle)

bottomRightCornerLong=fclBoxCenterLong−0.5*Length*cos(finalFCLCombinedAngle)+0.5*Width*sin(finalFCLCombinedAngle)

bottomRightCornerLat=fclBoxCenterLat−0.5*Length*sin(finalFCLCombinedAngle)−0.5*Width*cos(finalFCLCombinedAngle) Equation 1

wherein bottomLeftCornerLong denotes a longitudinal coordinate value of a left corner of a lower side of a LiDAR track, bottomLeftCornerLat denotes a lateral coordinate value of a left corner of a lower side of the LiDAR track, bottomRightCornerLong denotes a longitudinal coordinate value of a right corner of a lower side of the LiDAR track, bottomRightCornerLat denotes a lateral coordinate value of a right corner of a lower side of the LiDAR track, fclBoxCenterLong denotes a longitudinal coordinate value of a center portion of the LiDAR track, fclBoxCenterLat denotes a lateral coordinate value of a center portion of the LiDAR track, Length denotes a length value of the LiDAR track, finalFCLCombinedAngle denotes an angle of a first heading, Width: a width value of the LiDAR track).

For example, the left corner of the lower portion of the LiDAR track may be an output as the coordinate value (e.g., a longitudinal coordinate value (bottomLeftCornerLong) or the lateral coordinate value (bottomLeftCornerLat)).

Furthermore, the right corner of the lower portion of the LiDAR track may be output as the coordinate value (e.g., a longitudinal coordinate value (bottomRightCornerLong), or the lateral coordinate value (bottomRightCornerLat)).

Referring to FIG. 6, the sensor fusion system 200 may be configured to determine the first midpoint 61 of the first track side corresponding to the opposite side of the first heading 51 in the LiDAR track.

The sensor fusion system 200 may be configured to determine the first midpoint 61 of the first track side based on Equation 2 below.

$$finalRearBumperLongPos = fclBoxCenterLong - 0.5 * Length * cos ( finalFCLCombinedAngle ) \qquad Equation 2$$

$$finalRearBumperLatPos = fclBoxCenterLong - 0.5 * Length * sin ( finalFCLCombinedAngle )$$

The first midpoint 61 may be output as the coordinate value (i.e., a longitudinal coordinate value (finalRearBumperLongPos) or a lateral coordinate value (finalRearBumperLatPos)

The sensor fusion system 200 may be configured to determine a first predicted collision closest point (also referred to as a first point) from the vehicle 2 on the LiDAR track (405).

FIG. 7A illustrates a first situation in which an angle of the first straight line 73 (also referred to as an angle of the first midpoint 61) connecting the first midpoint 61 of the LiDAR track 71 and an angle of the first heading 51 are similar to (or equal to) each other with respect to the origin of the vehicle coordinate system.

In the first situation as shown in FIG. 7A, when the sensor fusion system 200 extracts the first closest point of potential collision based on the straight-line distance from the origin of the vehicle coordinate system to the LiDAR track 71, straight-line distances from the first midpoint 61 to the left corner and the right corner are similar (or equal), and thus the selection of the first closest point of potential collision may be unstable. For example, the sensor fusion system 200 may be configured to determine the first closest point of potential collision by selecting a point in the left corner and a point in the right corner with respect to the first midpoint 61 alternately in time frames.

FIG. 7B illustrates a second situation in which a difference value between the angle of the first straight line 73 connecting the first midpoint 61 of the LiDAR track 71-1 (also referred to as the angle of the first midpoint 61) and the angle of the first heading 51-1 is positive, based on the origin of the vehicle coordinate system.

Also, FIG. 7B is a diagram illustrating a third situation in which a difference value between an angle of the first straight line 73 connecting the first midpoint 61 of the LiDAR track 71-3 (also referred to as an angle of a first midpoint 61) and the angle of the first heading 51-3 is negative, based on the origin of the vehicle coordinate system.

For example, the second situation and the third situation may occur when the LiDAR track is located on a right lane of the vehicle 2.

In the second situation of FIG. 7B, when the sensor fusion system 200 extracts the first closest point of potential collision based on the straight-line distance from the origin of the vehicle coordinate system to the LiDAR track 71-1, the point at the right corner with respect to the first midpoint 61 may be erroneously determined as the first closest point of potential collision.

Also, in the third situation of FIG. 7B, when the sensor fusion system 200 extracts the first closest point of potential collision based on the lateral distance from the origin of the vehicle coordinate system to the LiDAR track 71-3, the point of the left corner of the track side facing the track side including the first midpoint 61 may be erroneously determined as the first closest point of potential collision.

Furthermore, although not shown, when the LiDAR track is located on the left lane of the vehicle 2, and a difference value between an angle of a first straight line connecting the first midpoint of the LiDAR track (also referred to as an angle of the first midpoint) and an angle of the first heading is positive, when the sensor fusion system 200 extracts the first closest point of potential collision based on the lateral distance from the origin of the vehicle coordinate system to the LiDAR track 71-1, a point of the left corner and a point of the right corner may be alternately selected based on the first midpoint.

Furthermore, although not illustrated, when the LiDAR track is located in the left lane of the vehicle 2, and a difference value between the angle of the first straight line connecting the first midpoint of the LiDAR track (also referred to as an angle of the first midpoint) and the angle of the first heading is negative, when the sensor fusion system 200 extracts the first closest point of potential collision based on a straight-line distance from the origin of the vehicle coordinate system to the LiDAR track 71-1, a point at the right corner based on the first midpoint 61 may be erroneously determined as the first closest point of potential collision

Accordingly, in the exemplary embodiment of the present disclosure, the situations may be categorized according to whether the LiDAR track is located in a same lane as the vehicle 2, in the left lane of the vehicle 2, or in the right lane of the vehicle 2, and the first closest point of potential collision may be determined by differently applying the criteria such as a straight line distance criterion, a perpendicular position criterion, or a horizontal position criterion from the origin of the vehicle coordinate system to the LiDAR track for each situation.

For example, when the LiDAR track is located in a same lane as the vehicle 2, the sensor fusion system 200 may be configured to determine the first TTC based on the straight distance or the end position. Furthermore, when the LiDAR track is located in the left lane or the right lane of the vehicle 2, the sensor fusion system 200 may be configured to determine the first closest point of potential collision based on the straight distance standard or the lateral position standard.

For example, when the LiDAR track is located in the right lane portion of the vehicle 2, and when the difference value between the angle of the first midpoint and the angle of the first heading based on the origin of the vehicle coordinate system is positive, the sensor fusion system 200 may be configured to determine the first closest point of potential collision based on the lateral distance. For example, the sensor fusion system 200 may be configured to determine the point at which the lateral distance is closest to the origin of the vehicle coordinate system on the LiDAR track based on the lateral distance as the first closest point of potential collision.

Furthermore, in the case where the LiDAR track is located in the right lane portion of the vehicle 2, when a difference value between the angle of the first midpoint and the angle of the first heading with respect to the origin of the vehicle coordinate system is negative, the sensor fusion system 200 may be configured to determine the first closest point of potential collision based on the straight-line distance. For example, the sensor fusion system 200 may be configured to determine a point at which a straight-line distance is closest to an origin of the vehicle coordinate system on the LiDAR track as the first closest point of potential collision based on the straight-line distance.

Furthermore, in the case where the LiDAR track is located in the left lane portion of the vehicle 2, when the difference value between the angle of the first midpoint and the angle of the first heading is positive based on the origin of the vehicle coordinate system, the sensor fusion system 200 may be configured to determine the first closest point of potential collision based on the straight distance. For example, the sensor fusion system 200 may be configured to determine a point at which a straight-line distance is closest to the origin of the vehicle coordinate system on the LiDAR track as the first closest point of potential collision based on the straight-line distance.

Furthermore, in the case where the LiDAR track is located on the left lane of the vehicle 2, when the difference value between the angle of the first midpoint and the angle of the first heading with respect to the origin of the vehicle coordinate system is negative, the sensor fusion system 200 may be configured to determine the first closest point of potential collision based on the lateral distance. For example, the sensor fusion system 200 may be configured to determine a point at which the lateral distance is closest to the origin of the vehicle coordinate system on the LiDAR track as the first closest point of potential collision based on the lateral distance.

The sensor fusion system 200 may be configured to determine whether the first closest point of potential collision is located on the left corner of the lower portion of the LiDAR track or the right corner position of the lower portion of the LiDAR track (407)

Referring back to FIG. 6, the sensor fusion system 200 may be configured to determine whether the first closest point of potential collision is located on the left lane or the right lane, with respect to the lane connecting the midpoint of the LiDAR track and the first midpoint of the lower portion of the first track side corresponding to the opposite side of the first heading.

For example, the sensor fusion system 200 can determine whether the first closest point of potential collision is located at the left corner or the right corner of the lower portion of the LiDAR track based on an equation of a straight-line and the coordinate value of the first closest point of potential collision.

For example, the equation of a straight line may be expressed as Ax+By+C=0, and A, B, and C (A, B, and C are real numbers), and x and y (coordinate values) may be determined based on Equation 3 below.

A=fclboxCenterLat−finalRearBumperLatPos

B=finalRearBumperLongPos−fclboxCenterLong

C=fclboxCenterLong*finalRearBumperLatPos−finalRearBumperLongPos*fclboxCenterLat Equation 3

The sensor fusion system 200 may be configured to determine that the first closest point of potential collision is located on the lower left corner of the LiDAR track when A×fclCPLongPos+B×fclCPLatPos+C<0. Here, fclCPLongPos denotes the longitudinal coordinate value of the first closest point of potential collision, and fclCPLatPos denotes the lateral coordinate value of the first closest point of potential collision.

Furthermore, the sensor fusion system 200 can determine that the first closest point of potential collision is located on the right corner of the lower portion of the LiDAR track when A×fclCPLongPos+B×fclCPLatPos+C>0.

The sensor fusion system 200 may be configured to determine the second heading of the sensor fusion track based on the first heading (409).

The sensor fusion system 200 may ignore the heading output of the actual sensor fusion track and newly determine the second heading of the sensor fusion track based on the above-described first heading.

Referring to FIG. 8, the sensor fusion track may include a rectangular box shape.

The sensor fusion system 200 may be configured to determine a direction toward the outside of the box shape from the midpoint 85 of the box shape (also referred to as the center portion point of the sensor fusion tack) to a direction perpendicular to each of four sides (also referred to as track sides) forming the box shape with the potential heading.

The sensor fusion system 200 may be configured to determine one potential heading corresponding to the first heading among the potential headings, that is, corresponding to the heading direction and heading angle of the first heading, as the second heading 81. For example, the sensor fusion system 200 may determine, as the second heading 81, one potential heading including a heading angle near the first heading among the potential headings.

The sensor fusion system 200 may be configured to determine the left corner position of the lower portion of the sensor fusion track and a right corner position of the lower portion of the sensor fusion track on the vehicle coordinate system based on the second heading (411).

Referring to FIG. 8, the sensor fusion system 200 may the left corner position of the lower portion of the sensor fusion track 801 and the right corner position of the lower portion of the sensor fusion track 803 based on the coordinate value of the center portion 85 of the sensor fusion track (longitudinal coordinate value dofBoxCenterLong, lateral coordinate value dofBoxCenterLat), the length of the sensor fusion track, the width of the sensor fusion track, and the angle of the second heading 81 (finalDOFCombinedAngle).

The sensor fusion system 200 may be configured to determine the positions of the left corner 801 and the right corner 803 on the lower portion of the sensor fusion track based on Equation 4 below.

bottomLeftCornerLong=dofBoxCenterLong−0.5*Length*cos(finalDOFCombinedAngle)−0.5*Width*sin(finalDOFCombinedAngle)

bottomLeftCornerLat=dofBoxCenterLat−0.5*Length*sin(finalDOFCombinedAngle)+0.5*Width*cos(finalDOFCombinedAngle)

bottomRightCornerLong=dofBoxCenterLong−0.5*Length*cos(finalDOFCombinedAngle)+0.5*Width*sin(finalDOFCombinedAngle)

bottomRightCornerLat=dofBoxCenterLat−0.5*Length*sin(finalDOFCombinedAngle−0.5*Width*cos(finalDOFCombinedAngle) Equation 4

wherein bottomLeftCornerLong denotes a longitudinal coordinate value of a left corner of a lower portion of a sensor fusion track, bottomLeftCornerLat denotes a lateral coordinate value of a left corner of a lower portion of the sensor fusion track, bottomRightCornerLong denotes a longitudinal left coordinate value of a right corner of a lower portion of the sensor fusion track, bottomRightCornerLat denotes a lateral coordinate value of a right corner of a lower portion of the sensor fusion track, dofBoxCenterLong denotes a longitudinal coordinate value of a center portion of the sensor fusion track, dofBoxCenterLat denotes a lateral coordinate value of a center portion of the sensor fusion track, Length denotes a length value of the sensor fusion track, finalDOFCombinedAngle denotes an angle of a second heading, Width denotes a width value of the sensor fusion track.

For example, the position of the left corner 801 at the lower portion of the sensor fusion track may be output as the coordinate value (e.g., a longitudinal coordinate value (bottomLeftCornerLong), or a lateral coordinate value (bottomLeftCornerLat)).

Furthermore, the position of the right corner 803 of the lower portion of the sensor fusion track may be output as the coordinate value (e.g., a longitudinal coordinate value (bottomRightCornerLong) or the lateral coordinate value (bottomRightCornerLat)).

The sensor fusion system 200 may determine, based on the location of the first closest point of potential collision, whether the second closest point of potential collision is located at the left corner of a lower portion of the sensor fusion track or the right corner of the lower portion of the sensor fusion track (413).

The sensor fusion system 200 may be configured to determine the location of the second closest point of potential collision of the sensor fusion track to be in a same direction as the first closest point of potential collision in the LiDAR track.

For example, when the first closest point of potential collision on the LiDAR track is located at the left corner, the sensor fusion system 200 may be configured to determine that the second closest point of potential collision is located above the left corner on the lower side of the sensor fusion track 801 on the vehicle coordinate system with respect to the second heading ΔT.

Furthermore, when the first closest point of potential collision on the LiDAR track is located at the right corner 803, the sensor fusion system 200 may be configured to determine that the second closest point of potential collision is located at the right corner of the lower portion of the sensor fusion track on the vehicle coordinate system based on the second heading.

The sensor fusion system 200 may update the sensor fusion track based on the first closest point of potential collision and the second closest point of potential collision (415).

The sensor fusion system 200 may be configured to determine a first difference value between the longitudinal coordinate value of the first closest point of potential collision and the longitudinal coordinate value of the second closest point of potential collision. Furthermore, the sensor fusion system 200 may be configured to determine a second difference value between the lateral coordinate value of the first closest point of potential collision and the lateral coordinate value of the second closest point of potential collision.

The sensor fusion system 200 may adjust a result value obtained by adding the first difference value and the longitudinal coordinate value of the center portion of the lower portion of the sensor fusion track to the longitudinal coordinate value of the center portion of the lower portion of the sensor fusion track, that is, the track side corresponding to the opposite side of the second heading (also referred to as a second track side). Furthermore, the sensor fusion system 200 may adjust a result value obtained by adding the second difference value and the lateral coordinate value of the center portion of the lower portion of the sensor fusion track to the lateral coordinate value of the center portion of the second track side corresponding to the lower portion of the sensor fusion track, that is, the opposite side of the second heading.

Referring to FIG. 9, the sensor fusion system 200 may be configured to determine a longitudinal offset longOffset, which is a longitudinal difference value between the first closest point of potential collision 91 and the second closest point of potential collision 93, and a lateral offset latOffset, which is a lateral difference value, based on the coordinate value of the first closest point of potential collision 91 of the LiDAR track and the second closest point of potential collision 93 of the sensor fusion track.

The sensor fusion system 200 may update and output a position (also referred to as coordinate values dofRearLongPos and dofRearLatPos) of a midpoint of a lower portion of the sensor fusion track, that is, the second track side, based on a longitudinal offset longOffset, a lateral offset latOffset, and a coordinate value of a midpoint of a predetermined lower portion of the sensor fusion track, that is, the track side (also referred to as the second track side) opposite to the second heading, as shown in Equation 5 below.

dofRearLongPos=dofRearLongPos+longOffset

dofRearLatPos=dofRearLatPos+latOffset

where, longOffset=fclCPLongPos−dofCPLongPos,

latOffset=fclCPLatPos−dofCPLatPos Equation 5

, wherein dofRearLongPos denotes a longitudinal coordinate value of a midpoint on a lower portion (also referred to as a second track side) of a sensor fusion track, dofRearLatPos denotes a lateral coordinate value of a midpoint on a lower side (also referred to as a second track side) of the sensor fusion track, longOffset denotes a longitudinal offset which is a longitudinal difference value between a first closest point of potential collision and a second closest point of potential collision, latOffset denotes a transverse offset which is a transverse difference value between the first closest point of potential collision and the second closest point of potential collision, fclCPLongPos denotes a longitudinal coordinate value of the first closest point of potential collision, dofCPLongPos denotes a longitudinal coordinate value of the second closest point of potential collision, fclCPLatPos denotes a lateral coordinate value of the first closest point of potential collision, dofCPLatPos denotes a lateral coordinate value of the second closest point of potential collision.

According to the above-described embodiments, before outputting the sensor fusion track, the sensor fusion system 200 may perform an operation of adjusting a closest point of potential collision to the self-driving vehicle in the sensor fusion track. For example, before the output of the sensor fusion track, the sensor fusion system 200 may perform an adjustment that matches closest point of potential collision to the self-driving vehicle of the sensor fusion track with the closest point of potential collision on the LiDAR track which may reflect the closest point of potential collision to the self-driving vehicle as accurately as possible.

Accordingly, the sensor fusion system 200 according to an exemplary embodiment of the present disclosure may solve a problem where it is difficult for the sensor fusion track output through the prior sensor fusion system to accurately reflect the position of the closest point of potential collision with the vehicle.

The above-described embodiments may be implemented in the form of a recording medium storing instructions executable by a computer. The instructions may be stored in the form of a program code, and when executed by a processor, may be configured to generate a program module to perform operations of the disclosed exemplary embodiments of the present disclosure. The recording medium may be implemented as a computer-readable recording medium.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for sensor fusion for a vehicle, the method comprising:
determining, by a processor, a first point corresponding to a closest point of a target object from the vehicle with respect to a potential collision based on a Light Detection and Ranging (LiDAR) track thereof and a heading of the vehicle;
determining, by the processor, a second point corresponding to a closest point of the target object from the vehicle with respect to a potential collision based on a sensor fusion track; and
updating, by the processor, the sensor fusion track based on the first point and the second point.

2. The method of claim 1, wherein the determining of the first point includes:
determining a first heading of the LiDAR track based on the heading of the vehicle;
determining a first midpoint of a first track side corresponding to an opposite side of the first heading in the LiDAR track; and
determining, in the LiDAR track, whether the first point is located at a left corner or a right corner of the first track side based on the first midpoint.

3. The method of claim 2, wherein the determining of the first heading includes:
determining four potential headings of the LiDAR track based on a shape of the LiDAR track; and
determining, as the first heading, a potential heading including a heading angle with a smallest difference from the heading angle of the vehicle among the four potential headings.

4. The method of claim 2, wherein determining of the first point includes:
determining a position of a left corner of the first track side and a position of a right corner of the first track side based on a center coordinate value of the LiDAR track, a length of the LiDAR track, a width of the LiDAR track, and an angle of the first heading.

5. The method of claim 2, wherein the determining of whether the first point is located at the left corner or the right corner is based on an equation of a straight line connecting a midpoint of the LiDAR track and the first midpoint and a coordinate value of the first point.

6. The method of claim 5, wherein the equation is Ax+By+C=0, A, B, and C being real numbers and x and y being coordinate values, and wherein when a sum of a value obtained by multiplying A by a longitudinal coordinate value of the first point, a value obtained by multiplying B by a lateral coordinate value of the first point, and a value of C is less than 0, the first point is determined to be located at the left corner, and when the sum is greater than 0, the first point is determined to be located at the right corner.

7. The method of claim 5, wherein the determining of the first point is based on a linear distance of the LiDAR track from an origin of a vehicle coordinate system, a lateral distance of the LiDAR track from the origin, or a longitudinal distance of the LiDAR track from the origin.

8. The method of claim 7, wherein, when the LiDAR track is located in a right lane of the vehicle, the determining of the first point includes:
determining the first point based on the lateral distance when a difference value between an angle of the first midpoint and an angle of the first heading is a positive value based on the origin of the vehicle coordinate system; and
determining the first point based on the linear distance when the difference value is a negative value.

9. The method of claim 7, wherein, when the LiDAR track is located in a left lane of the vehicle, the determining of the first point includes:
determining the first point based on the linear distance when a difference value between an angle of the first midpoint and an angle of the first heading is a positive value based on the origin of the vehicle coordinate system; and
determining the first point based on the lateral distance when the difference value is a negative value.

10. The method of claim 2, wherein the determining of the second point includes:
determining a second heading of the sensor fusion track based on the first heading;
determining that the second point is located at a left corner of a second track side corresponding to an opposite side of the second heading when the first point in the LiDAR track is located at the left corner of the first track side; and
determining that the second point is located at a right corner of the second track side when the first point in the LiDAR track is located at the right corner of the first track side.

11. The method of claim 10, further including:
determining a position of the left corner of the second track side and a position of the right corner of the second track side based on a center coordinate value of the sensor fusion track, a length of the sensor fusion track, a width of the sensor fusion track, and an angle of the second heading.

12. The method of claim 10, wherein the updating of the sensor fusion track includes:
adjusting a longitudinal coordinate value of a midpoint of the second track side based on a difference value between a longitudinal coordinate value of the first point and a longitudinal coordinate value of the second point; and
adjusting a lateral coordinate value of the midpoint of the second track side based on a difference value between a lateral coordinate value of the first point and a lateral coordinate value of the second point.

13. A system for sensor fusion for a vehicle, the system comprising:
a memory configured to store a sensor fusion track generated with respect to a target object; and
a processor electrically or communicatively connected to the memory,
wherein the memory stores instructions which are executable by the processor and the processor is configured, by executing the instructions, to:
determine a first point corresponding to a closest point of a target object from the vehicle with respect to a potential collision based on a Light Detection and Ranging (LiDAR) track thereof and a heading of the vehicle;
determine a second point corresponding to a closest point of the target object from the vehicle with respect to a potential collision based on a sensor fusion track; and
update the sensor fusion track based on the first point and the second point.

14. The system of claim 13, wherein the processor, to determine the first point, is further configured to:
determine a first heading of the LiDAR track based on the heading of the vehicle;
determines a first midpoint of a first track side corresponding to an opposite side of the first heading in the LiDAR track; and
determine, in the LiDAR track, whether the first point is located at a left corner or a right corner of the first track side based on the first midpoint.

15. The system of claim 14, wherein the processor, to determine the first point, is further configured to determine a position of a left corner of the first track side and a position of a right corner of the first track side based on a center coordinate value of the LiDAR track, a length of the LiDAR track, a width of the LiDAR track, and an angle of the first heading.

16. The system of claim 14, wherein the processor is further configured to determine whether the first point is located at the left corner or the right corner based on an equation of a straight line connecting a midpoint of the LiDAR track and the first midpoint and a coordinate value of the first point.

17. The system of claim 16, wherein the processor is further configured to determine the first point based on a linear distance of the LiDAR track from an origin of a vehicle coordinate system, a lateral distance of the LiDAR track from the origin, or a longitudinal distance of the LiDAR track from the origin.

18. The system of claim 14, wherein the processor, to determine the second point, is further configured to:
determine a second heading of the sensor fusion track based on the first heading;
determine that the second point is located at a left corner of a second track side corresponding to an opposite side of the second heading when the first point in the LiDAR track is located at the left corner of the first track side; and
determine that the second point is located at a right corner of the second track side when the first point in the LiDAR track is located at the right corner of the first track side.

19. The system of claim 18, wherein the processor is further configured to:
determine a position of the left corner of the second track side and a position of the right corner of the second track side based on a center coordinate value of the sensor fusion track, a length of the sensor fusion track, a width of the sensor fusion track, and an angle of the second heading.

20. The system of claim 18, wherein the processor is further configured to:
adjust a longitudinal coordinate value of a midpoint of the second track side based on a difference value between a longitudinal coordinate value of the first point and a longitudinal coordinate value of the second point; and
adjust a lateral coordinate value of the midpoint of the second track side based on a difference value between a lateral coordinate value of the first point and a lateral coordinate value of the second point.
